(19) United States
(12) Patent Application Publication
(10) Pub. No.: US 2026/0246896 A1
(43) Pub. Date: Aug. 20, 2026

(54) MULTI-MICROPHONE AUDIO ALIGNMENT

(71) Applicant: Zoom Communications, Inc., San Jose, CA (US)

(72) Inventors: Yifeng Fan, Foster City, CA (US); Qiang Gao, Pineville, NC (US); Zhaofeng Jia, Saratoga, CA (US); Xinyu Yao, Hefei (CN); Xiangming Zhu, Hefei (CN)

(73) Assignee: Zoom Communications, Inc., San Jose, CA (US)

(21) Appl. No.: 19/537,254

(22) Filed: Feb. 11, 2026

(30) Foreign Application Priority Data
Feb. 14, 2025 (CN) 202510170805.9

(51) Int. Cl. H04N 7/15; G06F 3/16

(52) U.S. Cl. CPC H04N 7/152; G06F 3/165

(57) ABSTRACT

Techniques for multi-microphone audio alignment are disclosed. An example method involves buffering multiple audio streams from multiple audio input devices for a duration. The method further involves generating multiple sets of transformed buffered audio streams by transforming each buffered audio stream using one or more transformation techniques. The method further involves, for each set of transformed buffered audio streams, determining one or more audio offsets for the corresponding audio stream using the multiple sets of transformed buffered audio streams. The method further involves, for each buffered audio stream, applying the determined one or more audio offsets to the buffered audio stream. The method further involves generating an audio output stream using the multiple buffered audio streams.

### CROSS-REFERENCE TO RELATED APPLICATION

This application claims priority to Chinese national application No. 202510170805.9 entitled “Multi-microphone Audio Alignment” and filed on Feb. 14, 2025, the entire disclosure of which is incorporated herein by reference for any purpose.

### FIELD

The present application generally relates to audio engineering, and more particularly relates to techniques for multi-microphone audio alignment.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices, according to some aspects of the present disclosure.

FIG. 2 shows an example system in which a video conference provider provides videoconferencing functionality to various client devices, according to some aspects of the present disclosure.

FIG. 3 shows an example user interface that may be used in some example systems configured for techniques for multi-microphone audio alignment, according to some aspects of the present disclosure.

FIG. 4 shows an example of a system implementing multi-microphone audio alignment, according to some aspects of the present disclosure.

FIG. 5 shows an example of an implementation of the audio alignment subsystem, according to some aspects of the present disclosure.

FIG. 6 shows a flowchart of an example method for providing multi-microphone audio alignment, according to some aspects of the present disclosure.

FIG. 7 shows a flowchart of an example method for determining that a set of transformed buffered audio streams satisfy one or more threshold criteria for providing multi-microphone audio alignment, according to some aspects of the present disclosure.

FIG. 8 shows a flowchart of an example method for determining that one or more audio offsets satisfy one or more threshold criteria for providing multi-microphone audio alignment, according to some aspects of the present disclosure.

FIG. 9 shows an example computing device suitable for use in example systems or methods for providing techniques for multi-microphone audio alignment, according to some aspects of the present disclosure.

### DETAILED DESCRIPTION

Examples are described herein in the context of techniques for multi-microphone audio alignment. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Video conferencing is an indispensable and integral part of modern living, in both enterprise and personal contexts. While a basic use case involving disparate participants each at a remote location is common, hybrid video conferencing, in which some participants are physically together, in-office while some others are remote, is increasingly common. For example, some participants may join a video conference, together, in conference room, while some other participants join the video conference from personal client devices at remote locations.

Integrated video conferencing systems such as the “Zoom Room” product by Zoom Communications, Inc. provide a seamless platform for high-definition video meetings by integrating software and hardware for both audio and video. Such integrated video conferencing systems are designed to meet the needs of hybrid work environments and may be situated in conference rooms or other public meeting places. Integrated video conferencing systems have a diverse spectrum of use cases and are suitable for diverse locations such as offices, classrooms, or homes. Integrated video conferencing systems can allow participants to join video conferences either on-site or remotely. For example, in a typical integrated video conferencing system session, some individuals may gather in a conference room equipped with an integrated video conferencing system, while others connect virtually using a client device executing video conference client software.

Audio configuring and engineering when using integrated video conferencing systems presents several distinct challenges. For example, an integrated video conferencing system may feature built-in microphones, positioned either near the video output device (e.g., television or monitor) or on a nearby table, to capture audio from participants in the conference room. However, generating high-quality audio for the remote participants from the audio captured in the conference room can be challenging in certain scenarios. For example, if the participants using an integrated video conferencing system are seated far from the microphones, the resultant generated audio captured from the various microphones may be degraded due to factors such as reverberation, signal scattering, or decay during transmission. For instance, for a meeting participant seated far from a microphone, the microphone may capture more sound reflecting off the walls and ceiling than the participant's voice directly, causing remote attendees to hear an echoey, indistinct version of what was said.

To tackle this challenge, some existing integrated video conferencing systems can enable participants to use their personal devices, such as laptops and smartphones, as audio input devices. In some cases, the hardware and software executing on such devices can implement certain sound engineering technologies (e.g., acoustic echo cancellation, noise suppression, automatic gain control, etc.) to enhance audio quality. This approach enables a dynamic multi-microphone system where the built-in microphones of the integrated video conferencing system work in tandem with the microphones of users' devices. Additionally, the integrated video conferencing system receives the benefit of multiple additional audio inputs using the general-purpose hardware of the users' devices.

More generally, multi-microphone systems may be widely used in various applications, including video conferencing, smart devices, and music or film production. In multi-microphone systems, microphones can be integrated into a single device, distributed across multiple devices, or a combination thereof. The various microphones in multi-microphone configurations can be configured to operate collaboratively to enhance audio quality, extend coverage areas, process directional audio, or provide spatial information.

One difficulty faced by designers and operators of systems involving multi-microphone configurations relates to accurate audio alignment. In this context, audio alignment can refer generally to the correspondence or level of similarity between audio signals using various standards of comparison (e.g., the time domain, the frequency domain, signal level/intensity, tone, etc.). Achieving audio alignment can be challenging in multi-microphone configurations, particularly when network congestion or other networking issues result in lost audio packets during data transmission. Audio alignment can likewise be lost due to microphone placement and the variable time of arrival of a given sound at each respective microphone, environmental factors (e.g., temperature or humidity), acoustic reflections, electronic latency introduced by signal processing, or other causes. Misaligned audio inputs, when played back simultaneously, can result in degraded audio output such as garbled speech or an echo effect. This effect can be magnified with larger and larger misalignments. Existing approaches lack any capability to precisely measure audio misalignment between various audio input sources or to correct such misalignment between any two audio input sources.

To address these difficulties, a user may employ techniques for multi-microphone audio alignment according to this disclosure. In one example, multiple audio streams captured by audio input devices in a multi-microphone system can be buffered and then processed into other formats (e.g., downsampling or conversion to the frequency domain using a Fourier transform). The processed audio can be used to determine degrees of misalignment or “offsets” between the various received audio streams using techniques such as the cosine similarity, cross-correlation, or other measures of similarity. The offsets can then be applied to the buffered audio inputs which can be combined to generate an aligned audio output signal.

In some examples, application of the offset can be contingent on a number of criteria to ensure that audio alignment measurements are based on sufficient data, data of sufficient quality, or data of the appropriate type, among other considerations. For instance, application of the offsets may be contingent on a sufficiently strong audio signal or the presence of human speech. Application of the offsets can be further contingent on a suitable degree of agreement among a number of different offset computations.

The techniques according to this disclosure are adaptable to both real-time audio and offline systems, which can ensure precise audio alignment under a variety of conditions. Additional example applications include wearable microphone systems (e.g., hearing aid and assistive listening devices), broadcast or recording setups, surround sound home theater systems, automotive hands-free communication setups, or spatial audio capture systems for augmented reality (“AR”) or virtual reality (“VR”) applications.

Example systems and methods according to the present disclosure provide significant improvements in the technical field of audio engineering. The disclosed methods can align digital audio input signals from among an arbitrary number of microphones or other audio input devices. The techniques disclosed herein enable calculation of an offset in multiple domains. For example, the techniques can combine offsets computed in the time-domain, the spectral-domain (e.g., frequency-domain), or other parameter spaces to achieve greater accuracy and robustness in alignment. The computed offsets are based on correlations or similarities established using a variety of technique to ensure high precision. The application of the computed offsets can be improved through dynamic alignment adjustments, which involves a mechanism to adjust misaligned audio streams using pre- or post-signal padding to further increase the alignment precision. The application of the computed offsets can be further improved through threshold-based validation techniques in which criteria for validating offsets (e.g., correlation thresholds or offset consistency thresholds) are verified prior to application of offsets to avoid application of misaligned adjustments in low-quality audio data scenarios. Moreover, speech-driven alignment can be incorporated by using voice activity detection (“VAD”) techniques to focus alignment exclusively on audio input that includes human speech to avoid errors caused by aligning noise or silence.

These illustrative examples are given to introduce the reader to the general subject matter discussed herein and the disclosure is not limited to these examples. The following sections describe various additional non-limiting examples of systems and methods for multi-microphone audio alignment.

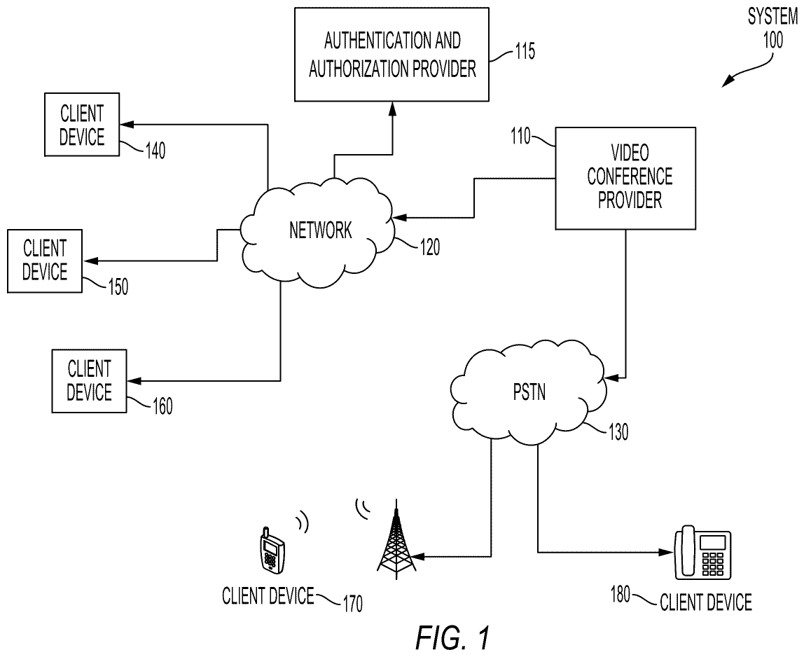

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the chat and video conference provider 110 over a public network.

The system optionally also includes one or more user identity providers, e.g., user identity provider 115, which can provide user identity services to users of the client devices 140-160 and may authenticate user identities of one or more users to the chat and video conference provider 110. In this example, the user identity provider 115 is operated by a different entity than the chat and video conference provider 110, though in some examples, they may be the same entity.

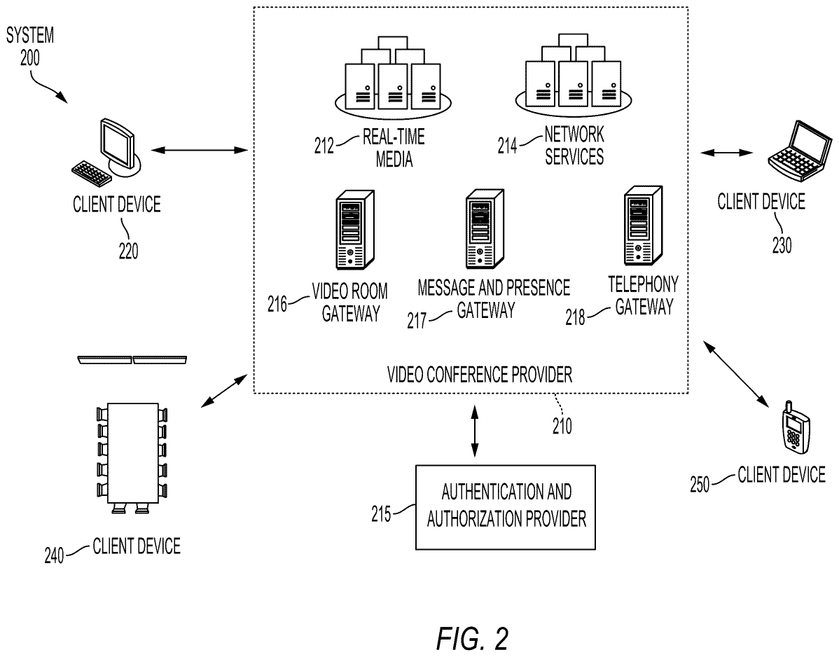

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the chat and video conference provider 110.

A user identity provider 115 may be any entity trusted by the chat and video conference provider 110 that can help identify a user to the chat and video conference provider 110. For example, a trusted entity may be a server operated by a business or other organization with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as two-factor authentication. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the chat and video conference provider 110.

When the user accesses the chat and video conference provider 110 using a client device, the chat and video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide user identification information to identify the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the chat and video conference provider 110, even in cases where the user has an authenticated identity and employs a client device capable of identifying the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more user identity providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the chat and video conference provider 210, or scheduling a new meeting, by interacting with the network services servers 214.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

In some embodiments, in addition to the video conferencing functionality described above, the chat and video conference provider 210 (or the chat and video conference provider 110) may provide a chat functionality. Chat functionality may be implemented using a message and presence protocol and coordinated by way of a message and presence gateway 217. In such examples, the chat and video conference provider 210 may allow a user to create one or more chat channels where the user may exchange messages with other users (e.g., members) that have access to the chat channel(s). The messages may include text, image files, video files, or other files. In some examples, a chat channel may be “open,” meaning that any user may access the chat channel. In other examples, the chat channel may require that a user be granted permission to access the chat channel. The chat and video conference provider 210 may provide permission to a user and/or an owner of the chat channel may provide permission to the user. Furthermore, there may be any number of members permitted in the chat channel.

Similar to the formation of a meeting, a chat channel may be provided by a server where messages exchanged between members of the chat channel are received and then directed to respective client devices. For example, if the client devices 220-250 are part of the same chat channel, messages may be exchanged between the client devices 220-240 via the chat and video conference provider 210 in a manner similar to how a meeting is hosted by the chat and video conference provider 210.

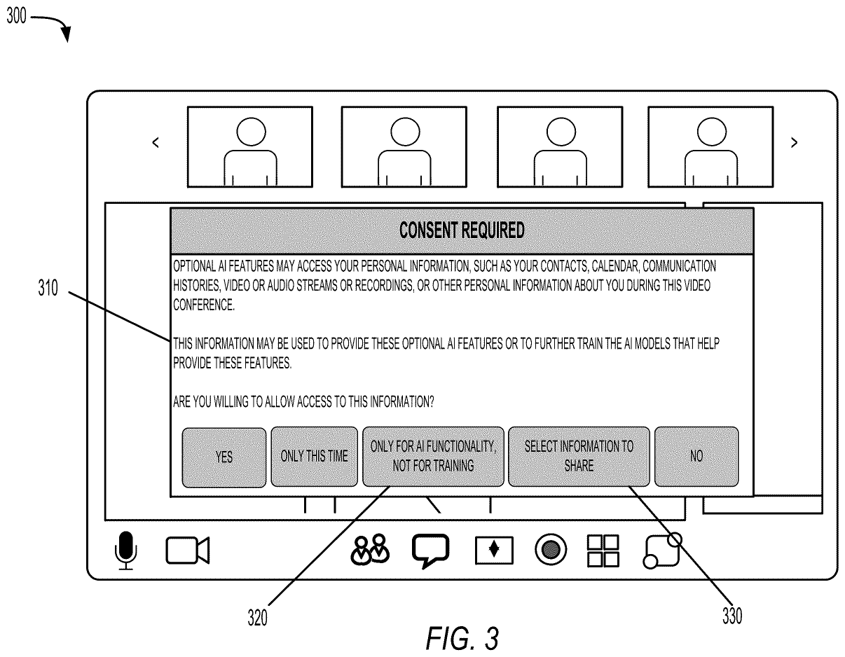

Turning next to FIG. 3, FIG. 3 shows an example user interface 300 that may be used in some example systems configured for multi-microphone audio alignment, according to some aspects of the present disclosure. In some examples according to the present disclosure, a user may select an option to use one or more optional AI features available from the virtual conference provider 302. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default—account owners and administrators control whether to enable these AI features for their accounts, and if enabled, individual users may determine whether to provide consent to use their personal information.

As can be seen in FIG. 3, a user has engaged in a video conference and has selected an option to use an available optional AI feature. In response, the GUI has displayed a consent authorization window 310 for the user to interact with. The consent authorization window 310 informs the user that their request may involve the optional AI feature accessing multiple different types of information, which may be personal to the user. The user can then decide whether to grant permission or not to the optional AI feature generally, or only in a limited capacity. For example, the user may select an option 320 to only allow the AI functionality to use the personal information to provide the AI functionality, but not for training of the underlying AI models. In addition, the user is presented with the option 330 to select which types of information may be shared and for what purpose, such as to provide the AI functionality or to allow use for training underlying AI models.

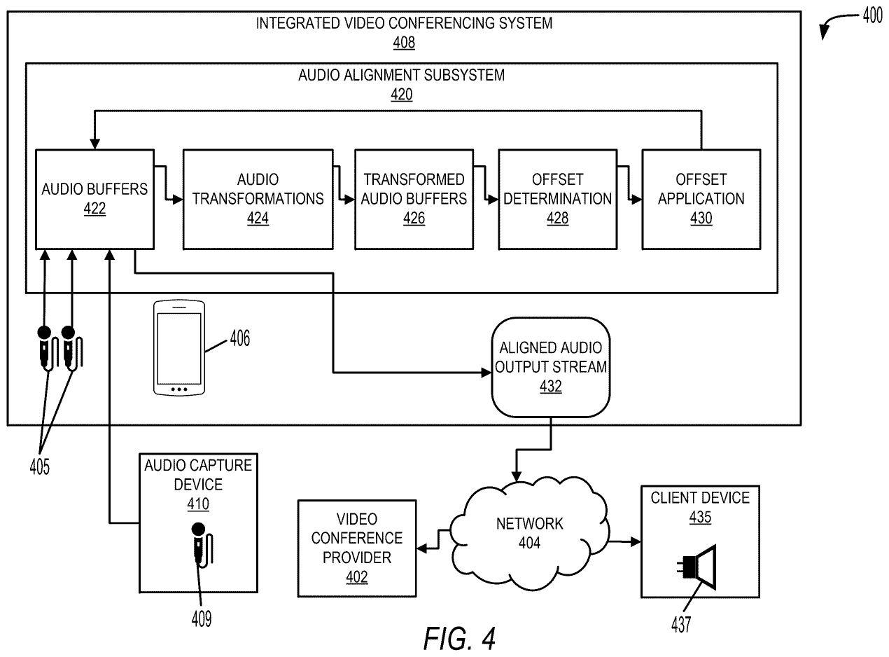

Referring now to FIG. 4, FIG. 4 shows an example of a system 400 implementing multi-microphone audio alignment, according to some aspects of the present disclosure. System 400 includes a remote client device 435 and integrated video conferencing system 408 communicatively coupled with video conference provider 402 over a network 404. Network 404 may include the Internet, public networks, private networks, or combinations thereof. Video conference provider 402 is typically a server or collection of servers, including a combination of privately or cloud-hosted devices. Video conference provider 402 may be similar, in some respects, to the video conference providers 110, 210 described above with respect to FIGS. 1 and 2.

The integrated video conferencing system 408, such as the “Zoom Room” produced by Zoom Communications, Inc., can provide a dedicated environment equipped for multi-participant video conferencing in one location such as a conference room with a shared camera or cameras capturing video conference participants. The integrated video conferencing system 408 may include a combination of hardware and software components. The integrated video conferencing system hardware may include devices for executing an integrated video conferencing system client application, a controller application, or other software or firmware for implementing integrated video conferencing system 408 functionality such as a laptop, desktop, dedicated hardware device, and so on. The integrated video conferencing system hardware may be configured to install and execute the integrated video conferencing system client application.

High-level video conferencing functionality can be provided by the integrated video conferencing system client application such as hosting video conferences or joining existing video conferences. The controller application can provide additional video conferencing user-facing functionality such as starting or ending video conferences, muting or unmuting microphones, and providing user interfaces for video conference configurations and settings.

For example, the controller application can provide interfaces or graphical user interfaces (“GUIs”) for setting up video conferences, starting and stopping video conferences, microphone controls (e.g., controls for muting or unmuting microphones), camera controls, and so on, represented in FIG. 4 as user interface 406. User interface 406 may be any smartphone, tablet, laptop, etc. suitable for operating the integrated video conferencing system 408 and conducting video conferences using the connected input and output devices, as well as the peripheral client devices in use as microphones, such as audio capture device 410.

The audio capture device 410 is communicatively coupled with the integrated video conferencing system 408 for use as an external microphone during a video conference. The audio capture device 410 and the integrated video conferencing system 408 may exchange data or other information via a remote network such as the Internet or over a local area network such as a LAN, WiFi, mesh, or other suitable network.

The audio capture device 410 and client device 435 may be any type of device capable of executing the appropriate client software for video conferencing, including multi-microphone audio alignment functionality. For example, the audio capture device 410 and client device 435 may be laptops, desktops, smartphones, tablets, internet protocol (IP) phones, and so on. The audio capture device 410 includes a microphone 409, which may be an internal, embedded microphone or an external microphone.

The integrated video conferencing system 408 includes microphones 405, one of which may be designated as a primary microphone. The primary microphone may be alternatively referred to as a pivot or reference microphone. The primary microphone can be a configurable microphone selection which is used as the reference to which all other audio inputs are aligned. The selection of the primary microphone may be made in accordance with the particular configuration of the audio input and output application or context. For example, if there is no significant physical, spatial, or electronic differences between the microphones 405, any can be chosen as the primary microphone (e.g., one can be chosen randomly).

In some examples, the integrated video conferencing system 408 may provide a predesignated primary microphone. Selecting the system's primary microphone exemplifies a choice made for a system having one central or primary microphone with a number of peripheral or auxiliary audio inputs that are sent to the integrated video conferencing system 408 for processing. In this example, during transmission from the peripheral audio inputs to the integrated video conferencing system 408, audio packets may be lost due to internet connectivity issues or other network disruptions. Consequently, the primary microphone of the integrated video conferencing system 408 can be a reliable reference for alignment.

The system 400 includes an audio alignment subsystem 420 including components for implementing multi-microphone audio alignment. The components of the audio alignment subsystem 420 can be implemented in hardware, software, or a combination of both. While the audio alignment subsystem 420 is shown as component of the integrated video conferencing system 408, in other examples the audio alignment subsystem 420 can be a standalone component communicatively coupled over network 404, a component of the video conference provider 402, or an application executed by the audio capture device 410, such as the video conference client application. For example, some or all components of the audio alignment subsystem 420 can be hosted by the video conference provider 402 or the audio capture device 410. For instance, the audio capture device 410 can buffer audio locally, transform audio locally, and then transmit the transformed audio to the audio alignment subsystem 420 hosted by the integrated video conferencing system 408. In another example, the offset calculations and applications could be performed at a remote server such as the video conference provider 402.

The audio alignment subsystem 420 includes audio buffers 422. The audio alignment subsystem 420 receives audio streams from various audio input devices for a duration (e.g., five seconds), during which the audio streams are buffered in the audio buffers 422. In this example, the audio buffers 422 are populated with audio streams input from each of the microphones 405, 409 or other audio input devices, which are stored in a buffer maintained in a memory or filesystem. For example, the audio buffers 422 may be implemented as circular buffers, ring buffers, or first-in-first-out (FIFO) queues stored in volatile memory such as RAM.

In some examples, analog audio must first be converted to digital audio using an analog to digital conversion (“ADC”) process. The audio inputs can be buffered using a suitable data format such as the waveform audio file format (“WAV”), a pulse code modulation (“PCM”) format, free lossless audio codec (“FLAC”), raw binary streams, and so on. The audio buffers 422 may store a predefined amount of audio data, corresponding to a specified amount of time (e.g., 10 milliseconds, 100 milliseconds, 1 second, etc.), amount of data (e.g., 1 MB of audio data), or other predefined limit. The multi-microphone audio alignment methods described herein can be applied periodically to each batch of buffered data (e.g., 1/second, 10/second, etc.).

The audio alignment subsystem 420 includes audio transformations components 424. Any number of transformations can be applied to the data stored in the audio buffers 422, whose output can be stored at transformed audio buffers 426. Example transformations can include downsampling, fast Fourier transform (“FFT”), or voice activity detection (“VAD”), as discussed further below. The transformed audio buffers 426 can be maintained in a suitable memory or filesystem. The transformed audio buffers 426 may be implemented as buffers similar to the audio buffers 422 (e.g., queues for downsampled buffers) or may store transformed data in other formats (e.g., arrays for binary flags for VAD).

The audio alignment subsystem 420 includes an offset determination component 428. The offset determination component 428 can use a similarity measure or other comparison technique to determine a degree of alignment between audio streams in the transformed audio buffers 426. Examples of techniques for measuring a degree of similarity include the cosine similarity, Euclidean distance, Manhattan distance, Kullback-Leibler (KL) divergence, and so on. Different similarity measures may be used for different transformed audio formats (e.g., time-domain vs. frequency-domain). The selected comparison technique can be used to determine a degree of offset to apply to audio steams buffered in the audio buffers 422. In some examples, the computed similarity measures can be converted into suitable units of audio offset (e.g., time) according to a predetermined conversion technique.

The calculated offsets are applied by offset application component 430. The offset application component 430 can first determine if certain criteria are satisfied, such as the presence of sufficient signal, sufficient voice content, threshold degrees of similarity, and so on. Then the offset application component 430 can then be applied to the audio streams buffered in the audio buffers 422, including the addition of padding for audio streams ahead of the primary reference audio stream or deletion of audio frames for audio stream behind the primary reference audio stream. Audio offsets can be computed and applied periodically (e.g., once per second) for the currently buffered audio streams, which are then replaced with a next batch of audio streams. In some examples, computed audio offsets can be stored in local memory to track the performance of the audio input devices or to apply persistent offsets when audio alignment changes infrequently, to reduce the computational load.

The offset application component 430 applies the computed offsets to the audio buffers 422. An aligned audio output stream 432 can then be generated by the audio alignment subsystem 420 through a suitable process of selecting, smoothing, and mixing the audio buffers 422 to generate the now-aligned audio output stream 432 using components not shown. The aligned audio output stream 432 can then be output to the video conference provider 402 to be dispatched to the remote client device 435 for playback over audio output device 437 (e.g., a speaker). In some examples, outputting the aligned audio output stream 432 can be followed by clearing the audio buffers 422 in advance of receiving the next cycle or batch of audio inputs.

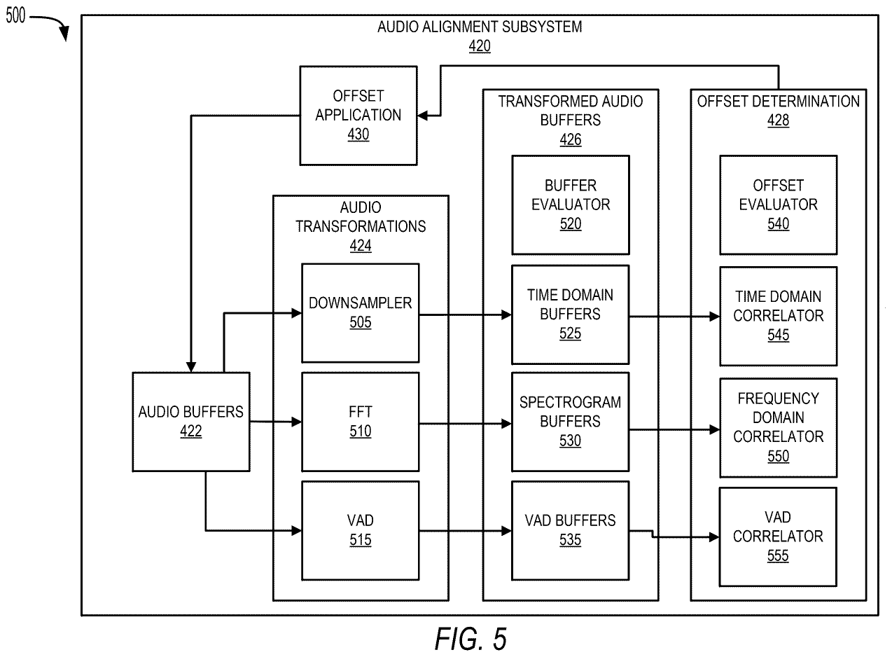

FIG. 5 shows an example of an implementation 500 of the audio alignment subsystem 420, according to some aspects of the present disclosure. In FIG. 5, the buffered audio streams in the audio buffers 422 are transformed by the audio transformations component 424. The audio transformations component 424 includes three example transformation components that transform the buffered audio streams into transformed buffered audio streams.

The buffered audio data stored in the multi-mic audio buffer can be further processed using any number of downstream processing techniques to facilitate alignment. Three examples include downsampling, Fast Fourier Transform (“FFT”), and VAD. The outputs of these processing operations can be stored in corresponding buffers or other suitable memories. In addition to the three examples described in detail with respect to FIG. 5, other transformations may be used to effect multi-microphone audio alignment according to this disclosure.

Downsampling may be implemented by downsampler 505. Downsampling can involve storing downsampled audio data in the time domain buffers 525 to calculate offsets in the time domain between the various input audio streams and a primary or reference audio stream. While computation of offsets could be effected using the uncompressed audio buffers 422, downsampling first can reduce computational costs and improve near-real-time performance for online audio playback. Downsampling a buffered digital waveform sampled at a given frequency can involve, for example, selecting a sample with some periodicity (e.g., every second or third sample) while discarding the rest to reduce the sampling rate.

Another transformation may involve transforming the time domain audio stream data buffered in the audio buffers 422 to the frequency domain. Transforming time domain data to the frequency domain can involve applying a mathematical transform that decomposes time domain data into constituent frequency components (e.g., which frequencies are present and at what intensity). The spectrogram buffers 530 can be used to store buffered audio as audio spectrograms (e.g., frequency-domain audio input) to compute alignment offsets from a spectral perspective. An FFT component 510 such as FFT software or hardware module can be used to convert the buffered audio streams to the frequency domain, resulting in frequency-domain information being stored in the spectrogram buffers 530 with a given frequency resolution or spacing between frequency bins in the FFT output.

Another transformation may involve transforming the time domain audio stream data buffered in the audio buffers 422 to a collection of binary indications of voice presence in buffered audio frames. The VAD buffers 535 can be used to store the output of a VAD algorithm applied by the VAD component 515 to samples of the buffered audio streams. For example, for a given audio time-domain sample (e.g., 1 second of audio) the VAD algorithm can output a Boolean indicating whether a probability that sample appears to include a human voice exceeds a predetermined threshold. The VAD algorithm can be implemented using, for example, digital signal processing (“DSP”) or machine learning (“ML”) techniques. In this case, the ML output can predict whether the probability that the sample appears to include a human voice exceeds the predetermined threshold.

An aggregate measure of the VAD algorithm output for a collection of buffered audio samples (e.g., 1 second of audio from all audio input sources) can be used to determine whether to apply audio alignment corrections to the respective collection to ensure alignment is used on speech portions of the audio where it is most effective. For example, application of certain audio alignment techniques to background noise can result in undesirable audio signal degradation.

The audio buffers 422 store incoming audio data from a number of different audio inputs and outputs it for further processing. In some examples, the audio inputs populating the audio buffers 422 may be well-aligned. In such cases, no alignments may be necessary. However, if misalignment is detected using the techniques disclosed below, adjustments can be made to the digital audio data buffered in the audio buffers 422 to ensure proper alignment.

In some examples, a primary audio stream can be designated, also referred to as a pivot or reference audio stream. The primary audio stream can be used as the reference to which all other audio streams are aligned. The selection of the primary audio stream may be made in accordance with the particular configuration of the audio input and output application or context. For example, if there is no significant physical, spatial, or electronic differences between the audio inputs, any can be chosen as the primary audio stream (e.g., one can be chosen randomly).

For an integrated video conferencing system 408, the system's primary microphone can be selected as the primary audio stream. Selecting the system's primary microphone exemplifies a choice made for a system having one central or primary microphone with a number of peripheral or auxiliary audio inputs that are sent to the client device of the integrated video conferencing system for processing. In this example, during transmission from the peripheral audio inputs to the integrated video conferencing system, audio packets may be lost due to internet connectivity issues or other network disruptions. Consequently, selecting the integrated video conferencing system 408 primary microphone as the primary audio stream can be a reliable reference for alignment.

In some examples, computation of alignment offset is preceded by threshold checks, implemented by the buffer evaluator 520. For example, determination of audio offsets for audio streams including only background noise may not result in any significant improvement to the audio output. Likewise, if there is insufficient signal, determination of audio offsets may again not result in any significant improvement to the audio output. Accordingly, before alignment, the buffer evaluator 520 can compute a number of threshold measures prior to computing and applying offsets.

In one example, a decibels relative to full scale (“dBFS”) measure can be computed that indicates the audio signal level or intensity. If the dBFS value is too low, the audio can be considered effectively silent, and application of offsets will not yield any significant improvements. For example, dBFS can be computed using a suitable hardware or software component of the buffer evaluator 520 to compare the maximum amplitude of each respective audio signal and compare it to the maximum possible amplitude for the particular audio format. dBFS can be computed for each audio stream in the time domain buffers 525. Audio streams for which dBFS does not exceed a predetermined threshold can be ignored (e.g., no offset applied). In some examples, if the dBFS for any audio stream does not exceed a predetermined threshold, audio offsets are not applied. In some examples, an aggregate measure of dBFS (e.g., average) can be computed and compared with a predetermined threshold.

In another example, a speech ratio can be computed using the data stored in the VAD buffers 535. The speech ratio can include the proportion of speech in the VAD buffers 535, determined by the ratio of positive (e.g., true Boolean) measures to total measures taken for the duration associated with the buffered audio streams in the audio buffers 422. If the speech ratio is too low, the alignment for the respective audio input can be ignored because aligning noise can cause significant errors. As with dBFS, this criteria can be applied for individual audio inputs or using an overall or aggregate measure for all audio streams.

If the threshold criteria such as dBFS and speech ratio satisfy their thresholds as determined by the buffer evaluator 520, the alignment process continues. Otherwise, the audio alignment subsystem 420 skips alignment for the cycle or batch under consideration. If the threshold criteria are satisfied, audio offsets can be calculated using a number of techniques, such as computing offsets for both the time and spectral (e.g., frequency) domains using the transformed buffered audio streams in the time domain buffers 525 and the spectrogram buffers 530.

Audio offsets can be determined by components of the offset determination component 428. The determined offsets can then be applied to the original, untransformed buffered audio streams in the audio buffers 422. An offset for the time-domain can be determined using data in the time domain buffers 525 by searching for the audio offset that yields the highest correlation between the audio to be aligned and the primary audio stream, which is among those transformed buffed audio streams in the time domain buffers 525. For example, a similarity measure such as the cosine similarity can be computed between the downsampled, buffered data in the time domain buffers 525 for each respective audio stream with the primary or reference audio input. The output of the cosine similarity, or other measure, can be converted to units of time-domain offset using a suitable conversion technique. Likewise, for the spectral-domain offset, a similarity measure such as the cosine similarity can be used based on the data in the spectrogram buffers 530.

The results from these processed buffers can be combined to calculate a final alignment offset, which represents the time shift required to align each audio stream with the primary audio stream. A negative offset indicates that the audio stream is ahead of the primary audio stream and needs to be delayed to be aligned. A positive offset indicates that the audio stream is lagging behind the primary audio stream and needs to be sped up to be aligned.

In some cases, audio offsets may only be applied when certain threshold criteria for application are satisfied to prevent application of a negligible audio offset or application of an audio offset that is inconsistently computed using differing techniques, indicating that the offset may not be accurately computed. In one example, correlations for each offset determined using different methods (e.g., time-domain and frequency-domain) for each audio stream can be determined. The two offsets can be combined based on specific criteria. For example, if the audio offsets determined for a particular audio stream using time-domain and frequency-domain data are equal or very close, according to a first predetermined maximum threshold (e.g., the difference is less than 50 milliseconds), and both offsets exceed a minimum predetermined threshold (e.g., greater than 10 milliseconds), an overall offset can be computed as the average of the two. Likewise, if only one offset exceeds the minimum predetermined threshold, but the offsets are reasonably close, according to a second predetermined maximum threshold (e.g., the difference is less than 100 milliseconds), the overall offset can be computed as the average of the two. In this example, the second criteria has a larger predetermined maximum threshold, since the individual offsets may be smaller. If neither condition is met, then it can be determined that no valid offset has been obtained, and application of the computed offsets can be skipped for the current cycle. These criteria and the values given are merely illustrative examples; various examples may have different criteria and threshold values according to specific applications and use cases.

If a valid offset for a particular audio input is determined, application of the offset can be applied to the audio buffers 422 using a suitable additive process. Shifting of the buffered time-domain audio forward or backward in time may result in empty time-domain value or time-domain values being shifted outside of the buffered window for certain audio inputs. In the latter case, data in the buffer can be discarded to effectively speed those audio inputs up. In the former case, zero-padding can be added to their beginning to effectively slow those audio inputs down. The amount of zero-padding or discarded data is determined by the offset value for the particular audio input. After application of the computed offsets to each of the buffered audio inputs, the audio alignment subsystem 420 can proceed to the next cycle or batch (e.g., 1 second window).

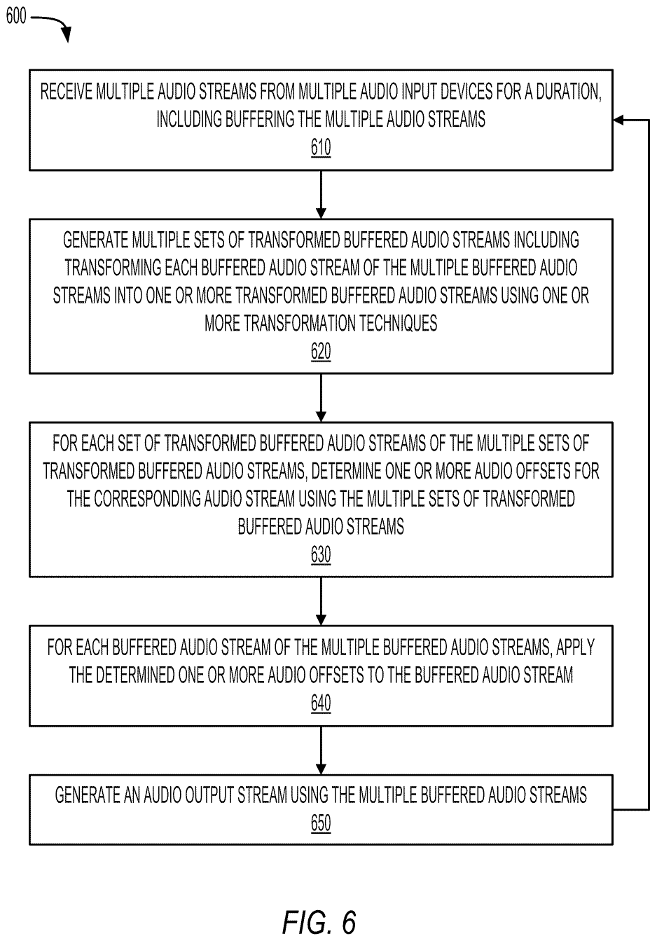

Referring now to FIG. 6, FIG. 6 shows a flowchart of an example method 600 for providing multi-microphone audio alignment, according to some aspects of the present disclosure. The description of the method 600 in FIG. 6 will be made with reference to FIGS. 4-5, however any suitable system according to this disclosure may be used, such as the example systems 100 and 200, shown in FIGS. 1 and 2. It should be appreciated that method 600 provides a particular method for providing multi-microphone audio alignment. Other sequences of operations may also be performed according to alternative examples. For example, alternative examples of the present disclosure may perform the steps outlined below in a different order. Moreover, the individual operations illustrated by method 600 may include multiple sub-operations that may be performed in various sequences as appropriate to the individual operation. Furthermore, additional operations may be added or removed depending on the particular applications. Further, the operations described in method 600 may be performed by different devices. For example, the description is given from the viewpoint of the integrated video conference system 408 or a component thereof such as the audio alignment subsystem 420 but other configurations are possible. One of ordinary skill in the art would recognize many variations, modifications, and alternatives.

The method 600 may include block 610. At block 610, a computing system, such as the audio alignment subsystem 420, receives multiple audio streams from multiple audio input devices for a duration, including buffering the multiple audio streams. For example, an integrated video conference system such as integrated video conference system 408 of FIG. 4 may include a number of built in microphones and be used in concert with several user devices, also used as microphones. The various audio streams from each of the microphones can be received and buffered using a suitable memory structure for a predefined duration such as 1 second. Each respective audio stream may be sampled at a particular rate, corresponding to the time density of data used to store the audio input's buffered data. One of the microphones may be designated as a primary or reference microphone, to which the other audio streams will be aligned.

At block 620, the computing system generates multiple sets of transformed buffered audio streams including transforming each buffered audio stream of the multiple buffered audio streams into one or more transformed buffered audio streams using one or more transformation techniques. Example transformations can include downsampling, FFT, VAD, among other transformations. The outputs of the transformations can be stored in buffers, queues, arrays, data structures, or other suitable formats, collectively referred to herein as buffers.

There may be a one-to-one or one-to-many relationship between the buffered audio frames and the transformed buffered audio frames. For example, downsampling may result in a 4-to-1 ratio of buffered to downsampled audio frames. In some examples, there may be a 1-to-1 ratio of buffered to downsampled audio frames, where each downsampled audio frame includes a smaller proportion of or compressed audio data. The number of buffered frequency domain values may be determined by the frame size used for the FFT and may be unrelated to the size of the audio buffers. VAD may be performed per-audio frame or per-group of audio frames (e.g., 10 20 millisecond audio frames at a time).

At block 630, the computing system, for each set of transformed buffered audio streams of the multiple sets of transformed buffered audio streams, determines one or more audio offsets for the corresponding audio stream using the multiple sets of transformed buffered audio streams. For example, measures such as the cosine similarity can be used to compute audio offsets between certain transformed audio streams and the primary or reference audio stream. The cosine similarity can be computed in various parameter spaces such as the time-domain, the frequency-domain, or other possible parameter spaces.

For example, in the time domain, if the downsampled buffer contains 10 audio frames, with 80 samples in each audio frame, the system can align these frames to the full buffer (which may contain corresponding frames with 160 samples each) by sliding each downsampled frame across candidate positions in the uncompressed buffer and computing the cosine similarity at each position. The cosine similarity may be determined between the vector of 80 amplitude samples from the downsampled audio frame and candidate 80-sample segments extracted from the corresponding 160-sample full (uncompressed) buffer. The audio offset may be selected as a position which maximizes this cosine similarity. Other processes besides cosine similarity, such as cross-correlation or dynamic time warping may likewise be used to similar effect.

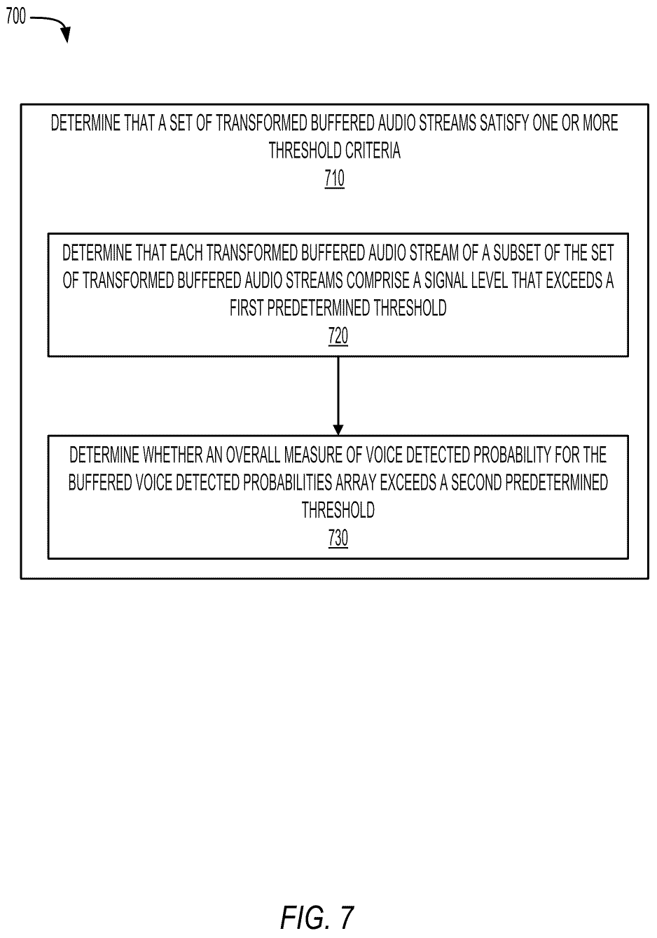

In some examples, determination of the offsets may be responsive to satisfaction of certain threshold criteria. An example implementation of such a scenario is described in FIG. 7.

At block 640, the computing system, for each buffered audio stream of the multiple buffered audio streams, applies the determined one or more audio offsets to the buffered audio stream. For each respective audio input stream if the second threshold criteria are satisfied, the one or more audio offsets can be aggregated (e.g., averaged) and then applied to the respective audio input stream. Leading elements may be deleted or added (e.g., padded) for positive offsets (e.g., shifting forward in time) or negative offsets (e.g., shifting backwards in time), respectively.

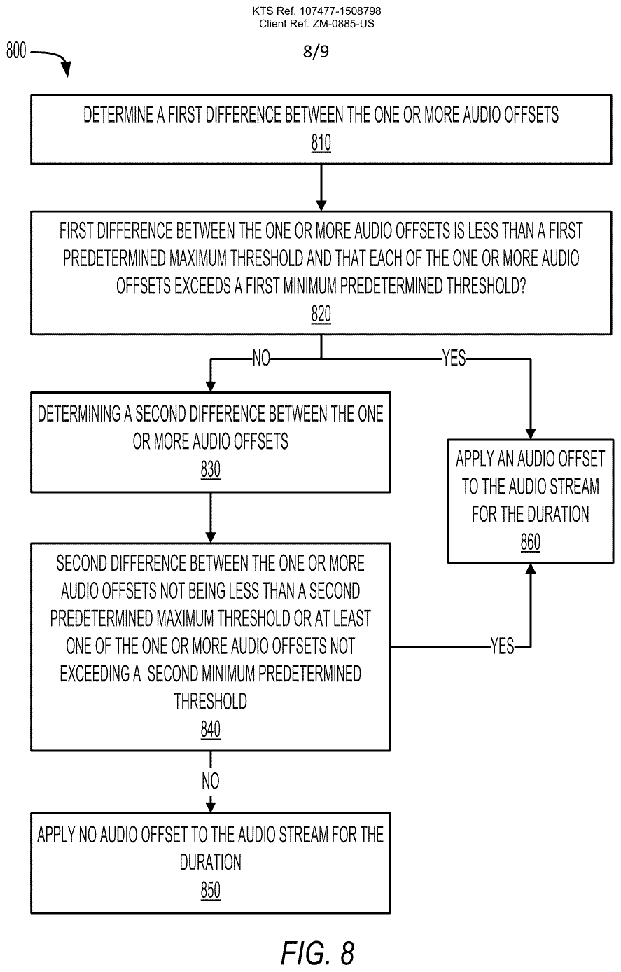

In some examples, application of the offsets may be responsive to satisfaction of certain threshold criteria. An example implementation of such a scenario is described in FIG. 8.

At block 650, the computing system generates an audio output stream using the multiple buffered audio streams. For example, an audio mixing component such as a digital signal processor can be used to mix or blend the aligned audio streams to generate the output audio stream. In some examples, generating the output audio stream may involve combining the aligned audio streams for the various audio capture devices with the audio stream corresponding to the primary audio input device.

After or in parallel with application of the audio offsets and generation of the audio output stream, processing of the next batch or cycle of buffered audio data can resume at block 610. Each batch or cycle may correspond to a fixed time interval (e.g., 100 20 millisecond audio frame) for all input audio streams. Each cycle begins when a new set of audio frames is buffered, undergoes transformation and alignment processing, and ends once (or in parallel with) offsets are applied and the aligned output is generated. Processing can resume with the next incoming batch of audio frames, enabling continuous, iterative alignment. The method 600 can halt when there is no more captured audio stream data to process.

FIG. 7 shows a flowchart of an example method 700 for determining that a set of transformed buffered audio streams satisfy one or more threshold criteria 710 for providing multi-microphone audio alignment, according to some aspects of the present disclosure. The description of the method 700 in FIG. 7 will be made with reference to FIGS. 4-5, however any suitable system according to this disclosure may be used, such as the example systems 100 and 200, shown in FIGS. 1 and 2. It should be appreciated that method 700 provides a particular method for providing multi-microphone audio alignment. Other sequences of operations may also be performed according to alternative examples. For example, alternative examples of the present disclosure may perform the steps outlined below in a different order. Moreover, the individual operations illustrated by method 700 may include multiple sub-operations that may be performed in various sequences as appropriate to the individual operation. Furthermore, additional operations may be added or removed depending on the particular applications. Further, the operations described in method 700 may be performed by different devices. For example, the description is given from the viewpoint of the integrated video conference system 408 or a component thereof such as the audio alignment subsystem 420 but other configurations are possible. One of ordinary skill in the art would recognize many variations, modifications, and alternatives.

The method 700 may include block 720. At block 720, a computing system, such as the audio alignment subsystem 420, determines that each transformed buffered audio stream of a subset of the set of transformed buffered audio streams comprise a signal level that exceeds a first predetermined threshold. A subset of the set of transformed buffered audio streams may be used since not all transformed buffered audio streams have an associated signal level.

For instance, the subset may include the downsampled time domain buffers. Determining that the time domain buffers have a signal level that exceeds a first predetermined threshold may involve computation of decibels relative to full scale (dBFS) for the buffered, downsampled data. For example, the computing system can calculate the dBFS for each downsampled audio frame by determining the root mean square (RMS) value of the audio frame's amplitude samples and converting to decibels according to

$$dBFS = 20 \cdot {log}_{10} ( \frac{R M S}{F S} )$$

where FS is a predetermined maximum possible amplitude. The dBFS values for the time buffers may be aggregated by determining the average or minimum dBFS across all audio frames in the buffer. If the resulting dBFS exceeds the first predetermined threshold (e.g., −40 dBFS), the buffer is considered to have sufficient signal level for alignment processing.

The method 700 may include block 730. At block 730, the computing system determines whether an overall measure of voice detected probability for the buffered voice detected probabilities array exceeds a second predetermined threshold. For example, a speech ratio can be determined for the VAD buffer shown in FIG. 5. The speech ratio may include the proportion of speech in the VAD buffer, determined by the ratio of true or “detected” values to the total number of Boolean values. If the speech ratio is too low, alignment can be skipped since aligning noise can cause significant errors. The second predetermined threshold may be configurable according to the particular application. For example, for an application in which high-fidelity speech is desired, a threshold speech ratio of 0.8 may be selected. For an instrumental musical performance, a threshold speech ratio of 0.4 may be selected.

FIG. 8 shows a flowchart of an example method 800 for determining that one or more audio offsets satisfy one or more threshold criteria for providing multi-microphone audio alignment, according to some aspects of the present disclosure. The description of the method 800 in FIG. 8 will be made with reference to FIGS. 4-5, however any suitable system according to this disclosure may be used, such as the example systems 100 and 200, shown in FIGS. 1 and 2. It should be appreciated that method 800 provides a particular method for providing multi-microphone audio alignment. Other sequences of operations may also be performed according to alternative examples. For example, alternative examples of the present disclosure may perform the steps outlined below in a different order. Moreover, the individual operations illustrated by method 800 may include multiple sub-operations that may be performed in various sequences as appropriate to the individual operation. Furthermore, additional operations may be added or removed depending on the particular applications. Further, the operations described in method 800 may be performed by different devices. For example, the description is given from the viewpoint of the integrated video conference system 408 or a component thereof such as the audio alignment subsystem 420 but other configurations are possible. One of ordinary skill in the art would recognize many variations, modifications, and alternatives.

The method 800 may include block 810. At block 810, a computing system, such as the audio alignment subsystem 420, determines a first difference between the one or more audio offsets. For example, if a first audio offset determined using the time-domain data in the time domain buffers 525 of FIG. 5 is +4 (e.g., 4 audio frames ahead of the primary audio stream) while a second audio offset determined using the frequency-domain data in the spectrogram buffers 530 of FIG. 5 is −2 (e.g., 2 audio frames behind the primary audio stream), then the difference is 6 audio frames.

The method 800 may include block 820. At block 820, the computing system determines whether the first difference between the one or more audio offsets is less than a first predetermined maximum threshold and that each of the one or more audio offsets exceeds a first minimum predetermined threshold. The first predetermined maximum threshold may be expressed as a number of audio frames (e.g., 1, 10, 100, etc.). At the same time, the magnitude of each of the audio offsets being compared can satisfy the first minimum predetermined threshold again expressed as a number of audio frames (e.g., 1, 10, 100, etc.). The first check ensures that the audio buffers do not diverge substantially and that the applied offset is consistent. The second check ensures a non-negligible misalignment before computational resources are expended applying the offsets.

If the first difference is less than the first predetermined maximum threshold and each of the one or more audio offsets exceeds the first minimum predetermined threshold, at block 860, the computing system applies an audio offset to the audio stream for the duration. Application of the audio offset may proceed as described with respect to block 650 in FIG. 6.

If the first difference is not less than the first predetermined maximum threshold or each of the one or more audio offsets does not exceed the first minimum predetermined threshold, at block 830, the computing system determines a second difference between the one or more audio offsets. This block can proceed substantially as described with respect to block 810 above.

The method 800 may include block 840. At block 840, the computing system determines whether the second difference is less than a second predetermined maximum threshold and that at least one of the one or more audio offsets exceeds a second minimum predetermined threshold. This block can proceed substantially as described with respect to block 820 above, except that the second predetermined maximum threshold is smaller than first predetermined maximum threshold. That is, a smaller maximum threshold can be used so long as at least of one of the determined audio offsets has significant magnitude.

If the second difference is less than a second predetermined maximum threshold and at least one of the one or more audio offsets exceeds a second minimum predetermined threshold, at block 860, the computing system applies an audio offset to the audio stream for the duration. Application of the audio offset may proceed as described with respect to block 650 in FIG. 6.

If neither of conditions checked in block 820 or 840 are satisfied, at block 850, the computing system applies no audio offset to the audio stream for the duration. Processing of captured audio data can resume with the next batch or cycle of buffered audio data as described with respect to block 650 of FIG. 6.

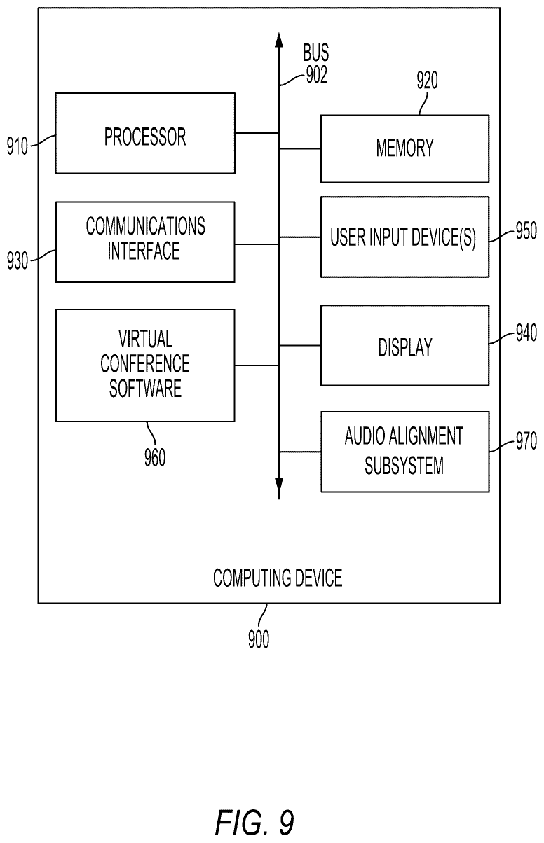

Referring now to FIG. 9, FIG. 9 shows an example computing device 900 suitable for use in example systems or methods for providing multi-microphone audio alignment, according to some examples of the present disclosure. The example computing device 900 includes a processor 910 which is in communication with the memory 920 and other components of the computing device 900 using one or more communications buses 902, including the audio alignment subsystem 970. The audio alignment subsystem 970 may be similar to the audio alignment subsystem 420 as described above. The processor 910 is configured to execute processor-executable instructions stored in the memory 920 to perform one or more methods for multi-microphone audio alignment, according to different examples, such as part or all of the example method 600 described above with respect to FIG. 6. The computing device 900, in this example, also includes one or more user input devices 950, such as a keyboard, mouse, touchscreen, microphone, etc., to accept user input. The computing device 900 also includes a display 940 to provide visual output to a user.

In addition, the computing device 900 includes virtual conferencing software 960 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 900 also includes a communications interface 930. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4).

Example 1 is a method, may include: receiving a plurality of audio streams from a plurality of audio input devices for a duration may include buffering the plurality of audio streams; generating a plurality of sets of transformed buffered audio streams may include transforming each buffered audio stream of the plurality of buffered audio streams into one or more transformed buffered audio streams using one or more transformation techniques; for each set of transformed buffered audio streams of the plurality of sets of transformed buffered audio streams, determining one or more audio offsets for the corresponding audio stream using the plurality of sets of transformed buffered audio streams; for each buffered audio stream of the plurality of buffered audio streams, applying the determined one or more audio offsets to the buffered audio stream; and generating an audio output stream using the plurality of buffered audio streams.

Example 2 is the method as example 1 describes, where determining the one or more audio offsets for the corresponding audio stream using the set of transformed buffered audio streams is responsive to determining that the set of transformed buffered audio streams satisfy one or more threshold criteria.

Example 3 is the method as either of examples 1 or 2 describe, where transforming each buffered audio stream of the plurality of buffered audio streams into one or more buffered transformed audio streams using the one or more transformation techniques may include: downsampling the buffered audio stream to generate a buffered downsampled audio stream; executing a fast Fourier transform (FFT) on the buffered audio stream to generate a buffered frequency-domain representation of the buffered audio stream; and determining a probability that each portion of each buffered audio stream includes voice to generate a buffered voice detected probabilities array.

Example 4 is the method as any of examples 1-3 describe, where determining that the set of transformed buffered audio streams satisfy the one or more threshold criteria may include: determining that each transformed buffered audio stream of a subset of the set of transformed buffered audio streams may include a signal level that exceeds a first predetermined threshold; and determining whether an overall measure of voice detected probability for the buffered voice detected probabilities array exceeds a second predetermined threshold.

Example 5 is the method as any of examples 1-4 describe, where the subset of the set of transformed buffered audio streams may include the buffered downsampled audio stream and the buffered frequency-domain representation.

Example 6 is the method as any of examples 1-5 describe, where applying the determined one or more audio offsets to the audio stream is responsive to determining that the one or more audio offsets satisfy one or more threshold criteria.

Example 7 is the method as any of examples 1-6 describe, where determining that the one or more audio offset satisfy the one or more threshold criteria may include: determining that a first difference between the one or more audio offsets is less than a first predetermined maximum threshold and that each of the one or more audio offsets exceeds a first minimum predetermined threshold.

Example 8 is the method as any of examples 1-7 describe, further may include: responsive to the first difference not being less than the first predetermined maximum threshold or each of the one or more audio offsets not exceeding the first minimum predetermined threshold: determining that a second difference between the one or more audio offsets is less than a second predetermined maximum threshold and at least one of the one or more audio offsets exceeds a second minimum predetermined threshold.

Example 9 is the method as any of examples 1-8 describe, further may include: responsive to the second difference between the one or more audio offsets not being less than the second predetermined maximum threshold or at least one of the one or more audio offsets not exceeding the second minimum predetermined threshold, applying no audio offset to the audio stream for the duration.

Example 10 is the method as any of examples 1-9 describe, where applying the determined one or more audio offsets to the audio stream may include: determining an overall audio offset may include aggregating the one or more audio offsets; and applying the overall audio offset to the audio stream.

Example 11 is the method as any of examples 1-10 describe, where aggregating the one or more audio offsets may include averaging the one or more audio offsets.

Example 12 is the method as any of examples 1-11 describe, where each audio stream of the plurality of audio streams may include a plurality of audio frames.

Example 13 is the method as any of examples 1-12 describe, where the plurality of audio input devices may include a primary audio input device corresponding to a primary audio stream.

Example 14 is the method as any of examples 1-13 describe, where applying the overall audio offset to the audio stream may include: adding zero-padding to the buffered audio stream corresponding to the audio stream when the audio stream is ahead of the primary audio stream; and deleting a number of buffered audio frames based on the overall audio offset from the buffered audio stream corresponding to the audio stream when the audio stream is behind the primary audio stream.

Example 15 is the method as any of examples 1-14 describe, where determining the one or more audio offsets for the corresponding audio stream using the plurality of sets of transformed buffered audio streams may include: for each transformed buffered audio stream of a subset of the set of transformed buffered audio streams, determine a correlation between the transformed buffered audio stream and a primary transformed buffered audio stream corresponding to the primary audio stream.

Example 16 is the method as any of examples 1-15 describe, where: the plurality of audio streams are received from one or more audio capture devices communicatively coupled with an integrated video conferencing system; and the integrated video conferencing system is joined to a video conference with one or more remote client device participants hosted by a video conference provider.

Example 17 is a non-transitory computer-readable storage medium storing processor-executable instructions configured to cause one or more processors to: receive a plurality of audio streams from a plurality of audio input devices for a duration may include buffering the plurality of audio streams; generate a plurality of sets of transformed buffered audio streams may include transform each buffered audio stream of the plurality of buffered audio streams into one or more transformed buffered audio streams using one or more transformation techniques; for each set of transformed buffered audio streams of the plurality of sets of transformed buffered audio streams, determine one or more audio offsets for the corresponding audio stream using the plurality of sets of transformed buffered audio streams; for each buffered audio stream of the plurality of buffered audio streams, apply the determined one or more audio offsets to the buffered audio stream; and generate an audio output stream using the plurality of buffered audio streams.

Example 18 is the non-transitory computer-readable storage medium as example 17 describes, where: the instruction to determine the one or more audio offsets for the corresponding audio stream using the set of transformed buffered audio streams is responsive to determining that the set of transformed buffered audio streams satisfy one or more threshold criteria; and the instruction to apply the determined one or more audio offsets to the audio stream is responsive to determining that the one or more audio offsets satisfy one or more threshold criteria.

Example 19 is a system may include: one or more non-transitory computer-readable media; and one or more processors communicatively coupled to the one or more non-transitory computer-readable media, the one or more processors configured to execute processor-executable instructions stored in the non-transitory computer-readable media to: receive a plurality of audio streams from a plurality of audio input devices for a duration may include buffering the plurality of audio streams; generate a plurality of sets of transformed buffered audio streams may include transform each buffered audio stream of the plurality of buffered audio streams into one or more transformed buffered audio streams using one or more transformation techniques; for each set of transformed buffered audio streams of the plurality of sets of transformed buffered audio streams, determine one or more audio offsets for the corresponding audio stream using the plurality of sets of transformed buffered audio streams; for each buffered audio stream of the plurality of buffered audio streams, apply the determined one or more audio offsets to the buffered audio stream; and generate an audio output stream using the plurality of buffered audio streams.

Example 20 is the system as example 19 describes, where: the instruction to determine the one or more audio offsets for the corresponding audio stream using the set of transformed buffered audio streams is responsive to determining that the set of transformed buffered audio streams satisfy one or more threshold criteria; and the instruction to apply the determined one or more audio offsets to the audio stream is responsive to determining that the one or more audio offsets satisfy one or more threshold criteria.

What is claimed is:

1. A method, comprising:
receiving a plurality of audio streams from a plurality of audio input devices for a duration comprising buffering the plurality of audio streams;
generating a plurality of sets of transformed buffered audio streams comprising transforming each buffered audio stream of the plurality of buffered audio streams into one or more transformed buffered audio streams using one or more transformation techniques;
for each set of transformed buffered audio streams of the plurality of sets of transformed buffered audio streams, determining one or more audio offsets for the corresponding audio stream using the plurality of sets of transformed buffered audio streams;
for each buffered audio stream of the plurality of buffered audio streams, applying the determined one or more audio offsets to the buffered audio stream; and
generating an audio output stream using the plurality of buffered audio streams.

2. The method of claim 1, wherein determining the one or more audio offsets for the corresponding audio stream using the set of transformed buffered audio streams is responsive to determining that the set of transformed buffered audio streams satisfy one or more threshold criteria.

3. The method of claim 2, wherein transforming each buffered audio stream of the plurality of buffered audio streams into one or more buffered transformed audio streams using the one or more transformation techniques comprises:
downsampling the buffered audio stream to generate a buffered downsampled audio stream;
executing a fast Fourier transform (FFT) on the buffered audio stream to generate a buffered frequency-domain representation of the buffered audio stream; and
determining a probability that each portion of each buffered audio stream includes voice to generate a buffered voice detected probabilities array.

4. The method of claim 3, wherein determining that the set of transformed buffered audio streams satisfy the one or more threshold criteria comprises:
determining that each transformed buffered audio stream of a subset of the set of transformed buffered audio streams comprise a signal level that exceeds a first predetermined threshold; and
determining whether an overall measure of voice detected probability for the buffered voice detected probabilities array exceeds a second predetermined threshold.

5. The method of claim 4, wherein the subset of the set of transformed buffered audio streams comprises the buffered downsampled audio stream and the buffered frequency-domain representation.

6. The method of claim 1, wherein applying the determined one or more audio offsets to the audio stream is responsive to determining that the one or more audio offsets satisfy one or more threshold criteria.

7. The method of claim 6, wherein determining that the one or more audio offset satisfy the one or more threshold criteria comprises:
determining that a first difference between the one or more audio offsets is less than a first predetermined maximum threshold and that each of the one or more audio offsets exceeds a first minimum predetermined threshold.

8. The method of claim 7, further comprising:
responsive to the first difference not being less than the first predetermined maximum threshold or each of the one or more audio offsets not exceeding the first minimum predetermined threshold:
determining that a second difference between the one or more audio offsets is less than a second predetermined maximum threshold and at least one of the one or more audio offsets exceeds a second minimum predetermined threshold.

9. The method of claim 8, further comprising:
responsive to the second difference between the one or more audio offsets not being less than the second predetermined maximum threshold or at least one of the one or more audio offsets not exceeding the second minimum predetermined threshold, applying no audio offset to the audio stream for the duration.

10. The method of claim 1, wherein applying the determined one or more audio offsets to the audio stream comprises:
determining an overall audio offset comprising aggregating the one or more audio offsets; and
applying the overall audio offset to the audio stream.

11. The method of claim 10, wherein aggregating the one or more audio offsets comprises averaging the one or more audio offsets.

12. The method of claim 10, wherein each audio stream of the plurality of audio streams comprises a plurality of audio frames.

13. The method of claim 12, wherein the plurality of audio input devices comprise a primary audio input device corresponding to a primary audio stream.

14. The method of claim 13, wherein applying the overall audio offset to the audio stream comprises:
adding zero-padding to the buffered audio stream corresponding to the audio stream when the audio stream is ahead of the primary audio stream; and
deleting a number of buffered audio frames based on the overall audio offset from the buffered audio stream corresponding to the audio stream when the audio stream is behind the primary audio stream.

15. The method of claim 13, wherein determining the one or more audio offsets for the corresponding audio stream using the plurality of sets of transformed buffered audio streams comprises:
for each transformed buffered audio stream of a subset of the set of transformed buffered audio streams, determine a correlation between the transformed buffered audio stream and a primary transformed buffered audio stream corresponding to the primary audio stream.

16. The method of claim 1, wherein:
the plurality of audio streams are received from one or more audio capture devices communicatively coupled with an integrated video conferencing system; and
the integrated video conferencing system is joined to a video conference with one or more remote client device participants hosted by a video conference provider.

17. A non-transitory computer-readable storage medium storing processor-executable instructions configured to cause one or more processors to:
receive a plurality of audio streams from a plurality of audio input devices for a duration comprising buffering the plurality of audio streams;
generate a plurality of sets of transformed buffered audio streams comprising transform each buffered audio stream of the plurality of buffered audio streams into one or more transformed buffered audio streams using one or more transformation techniques;
for each set of transformed buffered audio streams of the plurality of sets of transformed buffered audio streams, determine one or more audio offsets for the corresponding audio stream using the plurality of sets of transformed buffered audio streams;
for each buffered audio stream of the plurality of buffered audio streams, apply the determined one or more audio offsets to the buffered audio stream; and
generate an audio output stream using the plurality of buffered audio streams.

18. The non-transitory computer-readable storage medium of claim 17, wherein:
the instruction to determine the one or more audio offsets for the corresponding audio stream using the set of transformed buffered audio streams is responsive to determining that the set of transformed buffered audio streams satisfy one or more threshold criteria; and
the instruction to apply the determined one or more audio offsets to the audio stream is responsive to determining that the one or more audio offsets satisfy one or more threshold criteria.

19. A system comprising:
one or more non-transitory computer-readable media; and
one or more processors communicatively coupled to the one or more non-transitory computer-readable media, the one or more processors configured to execute processor-executable instructions stored in the non-transitory computer-readable media to:
receive a plurality of audio streams from a plurality of audio input devices for a duration comprising buffering the plurality of audio streams;
generate a plurality of sets of transformed buffered audio streams comprising transform each buffered audio stream of the plurality of buffered audio streams into one or more transformed buffered audio streams using one or more transformation techniques;
for each set of transformed buffered audio streams of the plurality of sets of transformed buffered audio streams, determine one or more audio offsets for the corresponding audio stream using the plurality of sets of transformed buffered audio streams;
for each buffered audio stream of the plurality of buffered audio streams, apply the determined one or more audio offsets to the buffered audio stream; and
generate an audio output stream using the plurality of buffered audio streams.

20. The system of claim 19, wherein:
the instruction to determine the one or more audio offsets for the corresponding audio stream using the set of transformed buffered audio streams is responsive to determining that the set of transformed buffered audio streams satisfy one or more threshold criteria; and
the instruction to apply the determined one or more audio offsets to the audio stream is responsive to determining that the one or more audio offsets satisfy one or more threshold criteria.
